(19) United States
(12) Patent Application Publication
(10) Pub. No.: US 2007/0204964 A1
(43) Pub. Date: Sep. 6, 2007

(54) Universal ladder drum for a horizontal blind assembly

(76) Inventor: Anthony B. Damiano, Pembroke Pines, FL (US)

Correspondence Address: ROBERT M. DOWNEY, P.A., 6751 N. FEDERAL HWY., SUITE 300, BOCA RATON, FL, 33487, US

(21) Appl. No.: 11/370,132

(22) Filed: Mar. 6, 2006

(51) Int. Cl. E06B 9/307

(52) U.S. Cl. 160/177 R

(57) ABSTRACT

A ladder drum for selectively positioning the slats of a horizontal blind assembly of the type incorporating tape ladders and string ladders and mounting to a control rod having a non-circular cross-sectional configuration comprises an elongated body having an exterior wall defining a substantially hollow interior. The exterior wall further defines a top body portion and a bottom body portion. The top body portion has one end open and an opposite end closed by a pin wall. The body further defines a longitudinal axis therethrough. The exterior wall of the body defines a longitudinal slot therealong in the top body portion wherein the slot has an open end at the open end of the top body portion for receiving the tape ladder and the string ladder. The exterior wall also defines a notch for receiving the string ladder. The bottom body portion defines a longitudinal recess for receiving the control rod therein.

### BACKGROUND OF THE INVENTION

1. Field of the Invention

The present invention relates to horizontal blinds used for window treatments and more particularly to rotatable drums for fixing the angular position of slats in a blind assembly.

2. Discussion of the Related Art

In decorating the interior of a home, people use a variety of items to complement the treatment of windows. Window treatments have two primary goals, one being decorative and the other being functional. The functionality of window treatments necessitate that a user be able to selectively block and unblock the transparency of the window for purposes of light control and privacy. Typically, a window is blocked by covering the window opening and unblocked by uncovering the window. One method for accomplishing the blocking and unblocking has been the usage of venetian blinds wherein a series of slats are suspended in a horizontally parallel fashion and vertically spaced at regular intervals. The slats are retained in their vertically spaced arrangement by a string or flexible tape ladder, wherein each individual slat is suspended in one ‘rung’ of the ladder.

In operation, a control mechanism is operated to vertically shift opposing sides of the ladder and thereby tilting the ladder rungs from an open position wherein the rungs are substantially horizontal to a closed position wherein the rungs are angled to a position between horizontal and vertical. The slats suspended by the rungs are thereby reoriented at a like angle to the rungs.

The control mechanism is typically found in a housing at the top of the window and comprises a rod extending along the width of the blind assembly with two or more cylindrical drums affixed to the rod such that rotation of the control rod about a longitudinal axis causes the drum to also rotate about that axis. The string or tape ladder is affixed about the drum such that rotation of the drum causes the opposing sides of the ladder to vertically shift in opposing directions thereby resulting in the desired angular positioning of the slats.

One such prior art drum is taught in U.S. Pat. No. 6,279,642 B1 to Liu and is illustrated and referred to here in FIGS. 1 through 4. The prior art drum 10 defines a central longitudinal square passageway 12 extending along the longitudinal axis of drum 10. Drum 10 is telescopically received over control rod 14 such that rotation of control rod 14 causes a like rotation of drum 10. Parallel and longitudinally opposed cantilevered bars 16 and 18 are located at the top of drum 10 for telescopically receiving thereover looped ends of a tape ladder. Similarly, the drum 10 can be rotated 180 degrees such that bottom of drum 10 faces up and then mounted over rod 14. The bottom of drum 10 defines notches 20 and 22 for receiving the ends of a string ladder.

The prior art drum described above has significant disadvantages. To change from a tape ladder to a string ladder or, conversely, from a string ladder to a tape ladder, the control rod with attached drums must be removed from the blind assembly, the old tapes or strings removed, and the drums must then be telesopically slid off the control rod, repositioned 180 degrees, and telescopically slid back onto the control rod. The drums then must also be laterally positioned along the control rod to align with the positions of the respective string or tape ladders. Such disassembly is very time consuming and fraught with potential for re-assembly errors resulting in a reassembled blind that works improperly or is visually unappealing.

Thus, what is desired is a ladder drum that can be readily affixed to a control rod without requiring a major disassembly of the blind mechanism and that does not require repositioning when changing from tape to string ladders or vice versa.

### SUMMARY OF THE INVENTION

One aspect of the present invention is a ladder drum for selectively positioning the slats of a horizontal blind assembly of the type incorporating tape ladders and string ladders and mounting to a control rod having a non-circular cross-sectional configuration. The ladder drum comprises an elongated body having an exterior wall defining a substantially hollow interior. The exterior wall further defines a top body portion and a bottom body portion. The top body portion has one end open and an opposite end closed by a pin wall. The body further defines a longitudinal axis therethrough. The exterior wall of the body defines a longitudinal slot therealong in the top body portion wherein the slot has an open end at the open end of the top body portion for receiving the tape ladder and the string ladder. The exterior wall also defines a notch for receiving the string ladder. The bottom body portion defines a longitudinal recess for receiving the control rod therein.

Another aspect of the present invention is a ladder drum for selectively positioning the slats of a horizontal blind assembly of the type incorporating tape ladders and string ladders and mounting to a control rod having a non-circular cross-sectional configuration. The ladder drum comprises an elongate body having a central longitudinal axis wherein the elongate body defines a hollow interior. Edges of the body define at least one longitudinal slot in a top body portion thereof and further define notches therein. The slot being oriented parallel to the longitudinal axis. A first and a second cantilevered tape fixing pin are positioned within said hollow body and are arranged parallel to the slot. A bottom portion of the body defines a control rod recess therein. The control rod recess is further defined by two vertical resilient walls extending from the bottom portion interiorly within the body and encompassing the longitudinal axis.

These and other advantages of the invention will be further understood and appreciated by those skilled in the art by reference to the following written specification, claims and appended drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a perspective view of a prior art drum;

FIG. 2 is a perspective view of the prior art drum of FIG. 1 rotated 180 degrees about it's longitudinal axis;

FIG. 3 is a cross-sectional view of the drum shown in FIG. 1 and taken along the line 3-3, FIG. 1;

FIG. 4 is a cross-sectional view of the rotated drum shown in FIG. 2 and taken along the line 4-4, FIG. 2;

FIG. 5 is a perspective view of a universal ladder drum embodying the present invention, wherein the drum is shown mounted on a tilt rod;

FIG. 6 is a plan view of the universal ladder shown in FIG. 5;

FIG. 7 is a cross-sectional view of the universal ladder drum shown in FIG. 6 and taken along the line 7-7, FIG. 6;

FIG. 8 is a cross-sectional view of the universal ladder drum shown in FIG. 6 and taken along the line 8-8, FIG. 6.

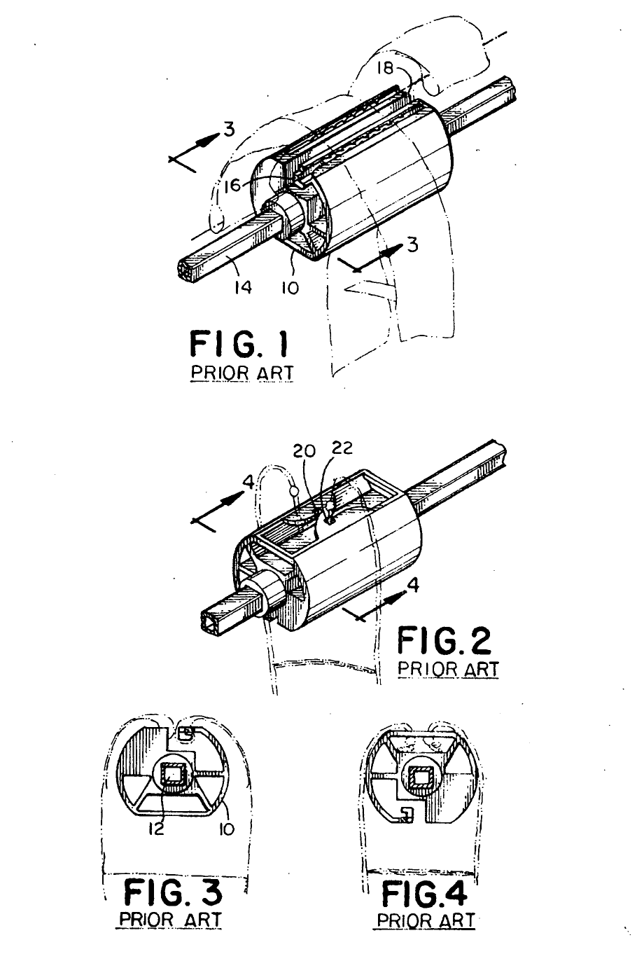

Like reference numerals refer to like parts throughout the several views of the drawings.

### DETAILED DESCRIPTION OF THE PREFERRED EMBODIMENTS

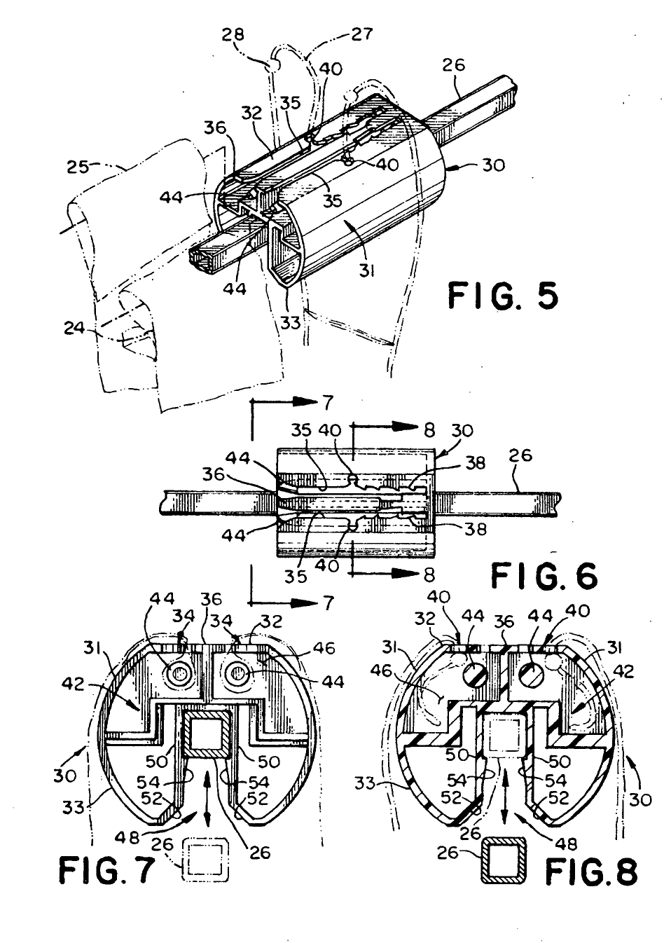

For purposes of description herein, the terms “upper”, “lower”, “left”, “rear”, “right”, “front”, “vertical”, “horizontal”, and derivatives thereof shall relate to the invention as oriented in FIG. 5. However, it is to be understood that the invention may assume various alternative orientations and step sequences, except where expressly specified to the contrary. While the present invention has been shown and described in accordance with preferred and practical embodiments thereof, it is recognized that departures from the instant disclosure are fully contemplated within the spirit and scope of the invention. Hence, specific dimensions and other physical characteristics relating to the embodiments disclosed herein are not to be considered as limiting, unless the claims expressly state otherwise.

Turning to the drawings, FIGS. 5-8 show a ladder drum 30 which is one of the preferred embodiments of the present invention and illustrate its various components. Ladder drum 30 is affixed over a control rod 26 which is typically of a non-circular cross-section and is here depicted as having a square cross-section although other polygonal shapes can be accommodated by the various embodiments contemplated herein. Ladder drum 30 has a generally cylindrical exterior wall 31 defining a hollow interior cavity 42 and a central axis coincident with control rod 26. The ladder drum 30 is further defined as having a top portion 32 incorporating features for attaching looped ends 25 of tape ladder 24 and string stops 28 of string ladders 27 and has a bottom portion 33 adapted for attaching to control rod 26.

Top portion 32 of ladder drum is defined by exterior wall 31 and a pin wall 46 at a back of ladder drum 30 thereby forming cavity 42. Exterior wall 31 is discontinuous at the top of ladder drum 30 wherein opposed edges 35 define a slot therebetween which is open to cavity 42. The top of top portion 32 is here depicted as having a flat planar surface. Those practiced in the art will readily recognize that the cylindrical exterior wall and the flat top illustrated and described herein are merely illustrative and other geometric configurations of the exterior of ladder drum 30 are also contemplated. A rib 36 extends vertically up through cavity 42 and terminates between edges 35 thereby forming two adjacent slots 34. Slots 34 are open at the front of ladder drum 30 and are closed at the back of ladder drum 30. A tape fixing pin 44 is located on each side of rib 36 and oriented parallel to slot 34. Each tape fixing pin 44 has one end affixed to pin wall 46 and extends therefrom in a cantilevered fashion. Slot edges 35 further define a notch 40 at a position intermediate to either end of slot 34. Further, at least a portion of edges 35 have a plurality of teeth extending into slots 34.

Bottom portion 33 of ladder drum 30 defines a recess 48 extending longitudinally along the bottom portion 33. Recess 38 is further defined by vertical walls 50 which extend upwardly to encompass the longitudinal axis and are laterally spaced one form the other to closely receive control rod 26. One or both of vertical walls 50 include a locking protrusion 54 extending into recess 48. The bottom portion of recess 48 is defined by angled walls 52 and is wider than the upper portion defined by walls 50.

In use, ladder drum 30 is placed over control rod 26 such that control rod 26 is initially received in the lower portion of recess 48 defined by angled walls 52. Ladder drum 30 is then forced down such that control rod 26 is translated upwardly into recess 48. Walls 50 are laterally resilient such that as control rod 26 engages lock protrusions 54, walls 50 are laterally displaced thereby permitting control rod 26 to pass between the opposed lock protrusions 54. When ladder drum 30 is fully engaged over control rod 26, lock protrusions 54 closely engage below the outer wall of the polygonally shaped control rod 26 thereby securely retaining ladder drum 30 on control rod 26. In such manner, ladder drum 30 can also be removed from control rod 26 by forcing ladder drum upwardly to disengage from control rod 26 thereby eliminating the need to remove control rod 26 from the blind assembly.

To attach tape ladder 24 to ladder drum 30, one each of looped ends 25 are passed on each side of ladder drum 30 and slid into respective slots 34 on either side of rib 36 such that each loop 25 is telescoped over tape fixing pin 44. When fully inserted in slots 34 and on pins 44, teeth 38 on edges 35 engage and grip tape loops 25 and prevent inadvertent withdrawal of tape loops from slots 34. In the event that a string ladder 27 is desired to be affixed to ladder drum 30 in lieu of tape ladder 24, each end of string ladder 27 is passed on each side of ladder drum 30, and slid into respective slots 34 to engage notches 40. Notches 40 are sized to closely receive the strings of string ladder 27. Each of the strings also includes a string stop 28 of larger diameter than notches 40 and is positioned within cavity 42. Thus, when a downward force is placed on string ladder 27, notches 40 prevent string stops 28 from pulling through slots 34 and thereby retaining string ladder 27 to ladder drum 30.

In the foregoing description those skilled in the art will readily appreciate that modifications may be made to the invention without departing from the concepts disclosed herein. Such modifications are to be considered as included in the following claims, unless these claims expressly state otherwise.

I claim:

1. A ladder drum for selectively positioning the slats of a horizontal blind assembly of the type incorporating tape ladders and string ladders and mounting to a control rod having a non-circular cross-sectional configuration, said ladder drum comprising:
an elongated body having an exterior wall defining a substantially hollow interior, said exterior wall further defining a top body portion and a bottom body portion, said top body portion having one end open and an opposite end closed by a pin wall and further defining a longitudinal axis therethrough;
said exterior wall further defining a longitudinal slot therealong in said top body portion, said slot having an open end at said open end of said top body portion for receiving the tape ladder and the string ladder;
said exterior wall further defining a notch for receiving the string ladder; and
said bottom body portion defining a longitudinal recess for receiving the control rod therein.

2. The ladder drum of claim 1 further including a tape fixing pin within said top body portion for receiving thereover an end of the tape ladder.

3. The ladder drum of claim 2 including a first tape fixing pin and a second tape fixing pin, said tape fixing pins parallel to said longitudinal axis and laterally spaced one from the other.

4. The ladder drum of claim 3 wherein said first and said second tape fixing pins are mounted to and extend from said pin wall in cantilever fashion.

5. The ladder drum of claim 3 further including a rib within said top body portion, an upper edge of said rib dividing said longitudinal slot into a first slot and a second slot.

6. The ladder drum of claim 5 wherein said rib is positioned between said first tape fixing pin and said second tape fixing pin.

7. The ladder drum of claim 6 wherein said body is substantially cylindrical and further wherein said top body portion defining said slots is substantially flat.

8. The ladder drum of claim 1 wherein an edge of said exterior wall defining a portion of said slot has at least one tooth extending therefrom for gripping the tape ladder.

9. The ladder drum of claim 1 wherein said exterior wall has a first edge and a second edge defining said slot, and further wherein each of said edges defines a notch for receiving an end of the string ladder.

10. The ladder drum of claim 1 wherein said bottom body portion includes longitudinally extending vertical walls, said vertical walls defining said control rod receiving recess.

11. The ladder drum of claim 10 wherein said vertical walls are laterally spaced about said longitudinal axis.

12. The ladder drum of claim 11 wherein said walls are laterally resilient.

13. The ladder drum of claim 12 wherein at least one of said walls includes a locking protrusion extending into said recess.

14. The ladder drum of claim 13 wherein a bottom portion of said vertical walls are angled to guide the control rod into said recess.

15. A ladder drum for selectively positioning the slats of a horizontal blind assembly of the type incorporating tape ladders and string ladders and mounting to a control rod having a non-circular cross-sectional configuration, said ladder drum comprising:
an elongate body having a central longitudinal axis, said elongate body defining a hollow interior and edges defining at least one longitudinal slot in a top body portion thereof, said slot parallel to said axis, said edges further defining notches therein;
a first and a second cantilevered tape fixing pin within said hollow body arranged parallel to said slot; and
a bottom portion of said body defining a control rod recess therein, said control rod recess further defined by two vertical resilient walls, said walls extending from said bottom portion interiorly within said body encompassing said longitudinal axis.

16. The ladder drum of claim 15 wherein said ladder drum further comprises a pin wall at a back of said body and wherein said first and said second tape fixing pins are mounted to and extend from said pin wall in cantilever fashion.

17. The ladder drum of claim 16 further including a rib within said top body portion, an upper edge of said rib dividing said longitudinal slot into a first slot and a second slot.

18. The ladder drum of claim 15 wherein each of said edges defining said slot have at least one tooth extending therefrom for gripping the tape ladder.

19. The ladder drum of claim 15 wherein at least one of said vertical resilient walls includes a locking protrusion extending into said recess.

20. The ladder drum of claim 19 wherein a bottom portion of said vertical walls are angled to guide the control rod into said recess.
